(19) United States
(12) Patent Application Publication
(10) Pub. No.: US 2011/0205976 A1
(43) Pub. Date: Aug. 25, 2011

(54) UE Specific Signaling Carrier Indicator For Carrier Aggregation

(75) Inventors: Sabine Roessel, Munchen (DE); Benoist Pierre Sebire, Tokyo (JP); Woonhee Hwang, Espoo (FI); Mieszko Chmiel, Wroclaw (PL)

(73) Assignee: Nokia Siemens Networks Oy

(21) Appl. No.: 12/708,902

(22) Filed: Feb. 19, 2010

(51) Int. Cl. H04W 72/00

(52) U.S. Cl. 370/329

(57) ABSTRACT

A node of a communication system having a plurality of aggregated component carriers CCs determines that a user equipment UE is capable of operating simultaneously on multiple CCs. During configuration or re-configuration of the UE, the node sends to the UE radio resource control RRC signaling along with an indication of which of the plurality of CCs to which the RRC signaling applies. In an embodiment the determining is from a UE capability information element that the UE sends which indicates at least a maximum number of downlink or uplink CCs on which the UE can simultaneously communicate. There may be a separate indication for each downlink and each uplink CC to which the RRC signaling applies, and the CCs for which the RRC signaling relates may be reconfigured upon handover to another cell or during any configuration/re-configuration.

### TECHNICAL FIELD

The exemplary and non-limiting embodiments of this invention relate generally to wireless communication systems, methods, devices and computer programs and, more specifically, relate to wireless control signaling in a multi-carrier or carrier aggregation system.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

3GPP third generation partnership project

ARFCN absolute radio frequency channel number

CA carrier aggregation

CC component carrier

DCCH dedicated control channel

DL downlink (eNB to UE)

DRB data radio bearer

eNB EUTRAN Node B (evolved Node B/base station)

EGCI EUTRAN cell global identifier

EUTRAN evolved UTRAN (LTE)

IE information element

IMT international mobile telecommunications

ITU-R international telecommunication union-radio

LTE long term evolution

MM/MME mobility management/mobility management entity

PCI physical cell identifier

PDCCH physical downlink control channel

PDSCH physical downlink shared channel

PMI precoding matrix index

PUSCH physical uplink shared channel

RAT radio access technology

RI rank indicator

RRC radio resource control

SC-FDMA single carrier, frequency division multiple access

SPS semi persistent scheduling

SRB signaling radio bearer

UE user equipment

UL uplink (UE to eNB)

UTRAN universal terrestrial radio access network

In the communication system known as evolved UTRAN (E-UTRAN, also referred to as UTRAN-LTE, E-UTRA or 3.9G), the LTE Release 8 is completed, the LTE Release 9 is being standardized, and the LTE Release 10 is currently under development within the 3GPP. In LTE the downlink access technique is OFDMA, and the uplink access technique is SC-FDMA, and these access techniques are expected to continue in LTE Release 10.

FIG. 1 reproduces Figure 4.1 of 3GPP TS 36.300, V8.6.0 (2008-09), and shows the overall architecture of the E-UTRAN system. The EUTRAN system includes eNBs, providing the EUTRA user plane and control plane (RRC) protocol terminations towards the UE. The eNBs are interconnected with each other by means of an X2 interface. The eNBs are also connected by means of an S1 interface to an evolved packet core, more specifically to a MME and to a Serving Gateway. The S1 interface supports a many to many relationship between MMEs/Serving Gateways and the eNBs.

Of particular interest herein are the further releases of 3GPP LTE targeted towards future IMT-Advanced systems, referred to herein for convenience simply as LTE-Advanced (LTE-A). LTE-A is directed toward extending and optimizing the 3GPP LTE Release 8 radio access technologies to provide higher data rates at very low cost. LTE-A will most likely be part of LTE Release 10. LTE-A is expected to use a mix of local area and wide area optimization techniques to fulfill the ITU-R requirements for IMT-Advanced while keeping the backward compatibility with LTE Release 8.

There is a bandwidth extension beyond 20 MHz in LTE-Advanced which is to be done via carrier aggregation (CA). This is shown conceptually at FIG. 1B in which there are 5 CCs aggregated to form one larger LTE-Advanced bandwidth. Each CC has DL and UL resources for enabling increased data rates such as for example by simultaneously scheduling an active UE across multiple CCs to better distribute traffic.

In general for the LTE-A CA concept, at least one of the CCs is a stand-alone CC and so is backwards compatible with 3GPP Release 8 UEs. LTE-Aterminals can receive or transmit simultaneously on multiple aggregated CCs. Each CC in the overall bandwidth may be a Release 8 compatible stand alone CC, or some may not be (thus violating the LTE Release 8 fixed duplex gap), and further some may be extension carriers which cannot exist stand-alone and which are tied to a stand-alone CC. See for example document R1-092575 (3GPP TSG RAN WG1 Meeting #57bis, Los Angeles, Calif., USA, Jun. 29 to Jul. 3, 2009 by Nokia). While the example at FIG. 1B illustrates 5 CCs of 20 MHz each spanning a total contiguous bandwidth of 100 MHz, other embodiments of CA may have non-contiguous CCs and/or CCs which do not even belong the same frequency band (for example the spectrum blocks might even be far apart in terms of frequency such as 700 MHz and 2.1 GHz). Other CA embodiments may have an asymmetric DL/UL CA which for example may be built by combining a frequency division duplex FDD carrier with a time division duplex TDD carrier. LTE-A is not the only CA-type system.

One premise in LTE-A to date is that a UE always camps on one cell only. If the UE initiates an RRC connection establishment procedure, it accesses this one cell via a random access procedure. In order to minimize the changes to existing RRC procedures, the one cell used for RRC connection establishment procedure is the serving cell of Release 8, which is the one cell that serves as a reference for mobility and security (one ECGI, one PCI and one ARFCN). For handover in LTE-A, the reconfiguration RRC procedure can also be kept similar to LTE Release 8 if one considers the cell where the UE performs a random access procedure at handover as the serving cell or serving component carrier. Release 8 has no component carriers because Release 8 by itself is not multi-carrier, but the Release 8 cell on which RRC connection establishment and re-establishment takes place in LTE-A is on a serving CC.

It has already been agreed in LTE-A discussions that from the user plane perspective CA is invisible to the layers (such as layers 1 and 2) above the medium access control MAC layer. Hence, transmission of SRBs (for LTE-A UEs) happens regardless of the DL CC or the UL CC used. This means that RRC signaling messages may reach the LTE-Advanced UE on any DL CC that is within the (current) UE's DL CC set. However, the information in an RRC message may refer to a single or subsets of the (current) UE's DL CC set and/or UE's UL CC set only. In LTE Release 8 there is no carrier ambiguity for RRC signaling message contents. The SRB is by definition on the serving cell/component carrier and refers to DL as well as UL on that same component carrier.

### SUMMARY

The foregoing and other problems are overcome, and other advantages are realized, by the use of the exemplary embodiments of this invention.

In a first aspect thereof the exemplary embodiments of this invention provide a method, comprising: determining, by an apparatus of a communication system having a plurality of aggregated component carriers, that a user equipment is capable of operating simultaneously on multiple component carriers; and during configuration or re-configuration of the user equipment, the apparatus sending to the user equipment radio resource control signaling together with an indication of which of the plurality of component carriers to which the radio resource control signaling applies.

In a second aspect thereof the exemplary embodiments of this invention provide an apparatus comprising at least one processor and at least one memory including computer program code. The at least one memory and the computer program code are configured, with the at least one processor, to cause the apparatus to perform: determining that a user equipment is capable of operating simultaneously on multiple component carriers of a plurality of aggregated component carriers of a communication system; and during configuration or re-configuration of the user equipment, sending to the user equipment radio resource control signaling together with an indication of which of the plurality of component carriers to which the radio resource control signaling applies.

In a third aspect thereof the exemplary embodiments of this invention provide a computer readable memory storing a program of computer readable instructions that when executed by a processor result in actions comprising: determining that a user equipment is capable of operating simultaneously on multiple component carriers of a communication system having a plurality of aggregated component carriers; and during configuration or re-configuration of the user equipment to a cell of the communication system, sending to the user equipment radio resource control signaling together with an indication of which of the plurality of component carriers to which radio resource control signaling applies.

In a fourth aspect thereof the exemplary embodiments of this invention provide a method comprising: during configuration or re-configuration in a communication system having a plurality of aggregated component carriers, an apparatus receiving radio resource control signaling together with an indication of which of the plurality of component carriers to which the radio resource control signaling applies; and the apparatus utilizing the indication to determine at least one of a downlink component carrier and an uplink component carrier on which to apply the radio resource control signaling.

In a fifth aspect thereof the exemplary embodiments of this invention provide an apparatus comprising at least one processor and at least one memory including computer program code. The at least one memory and the computer program code are configured, with the at least one processor, to cause the apparatus to perform: during configuration or re-configuration in a communication system having a plurality of aggregated component carriers, receiving radio resource control signaling together with an indication of which of the plurality of component carriers to which the radio resource control signaling is to be applied; and utilizing the indication to determine at least one of a downlink component carrier and an uplink component carrier on which to apply the radio resource control signaling.

In a sixth aspect thereof the exemplary embodiments of this invention provide a computer readable memory storing a program of computer readable instructions that when executed by a processor result in actions comprising: during configuration or re-configuration to a communication system having a plurality of aggregated component carriers, receiving radio resource control signaling together with an indication of which of the plurality of component carriers to which the radio resource control signaling is to be applied; and utilizing the indication to determine at least one of a downlink component carrier and an uplink component carrier on which to apply the radio resource control signaling.

These and other aspects of the invention are detailed more fully below.

### BRIEF DESCRIPTION OF THE DRAWINGS

FIG. 1A reproduces Figure 4 of 3GPP TS 36.300, and shows the overall architecture of the E-UTRAN system.

FIG. 1B is a schematic diagram of a carrier aggregation of five component carriers into a single LTE-Advanced bandwidth, which represents an exemplary environment in which these teachings can be used to advantage.

FIG. 2 is a carrier aggregation similar to that of FIG. 1B but showing RRC signaling received on CC#3 with an indication of another CC to which the RRC signaling applies according to an exemplary embodiment of the invention.

FIG. 3A is an exemplary RRC Configuration message that is modified to include DL and UL signaling CC indicators and UL/DL CC lists according to an exemplary embodiment of the invention.

FIG. 3B is an exemplary information element DLPhysicalConfigDedicated-R10 used to make changes to the DL CC physical configuration according to an exemplary embodiment of the invention.

FIG. 4 shows a simplified block diagram of certain apparatus according to various exemplary embodiments of the invention.

FIG. 5 shows a more particularized block diagram of a user equipment such as that shown at FIG. 4.

FIG. 6A-B are two logic flow diagrams that illustrates the operation of a method, and a result of execution of computer program instructions embodied on a computer readable memory, in accordance with the exemplary embodiments of this invention from the perspective of a network element and the user equipment, respectively.

### DETAILED DESCRIPTION

It is agreed in 3GPP discussions for LTE-A that there will be specified a UE DL CC set, and potentially as well a UE UL CC set. For Release 8 UEs there will of course be only one DL CC and one UL CC and these will be the same CC of the CA, since the UEs that are compatible with only Release 8 can access only one CC at a time. For the LTE-A compatible UEs, the DL CC set (and also the UL CC set if applicable) may include any integer number of CC between one and the total number of CCs in the whole CA.

It is assumed that the UE capability information from 3GPP Release 8 will be adopted in LTE-A but extended there such that the eNB will get knowledge about the UE's capability for DL and UL CC set. These of course will be the LTE-A compatible UEs, and this extended UE capability information will inform of the maximum number of CCs that can be included in a CC active set for that UE. For example, it may be that in a CA system with eight aggregated CCs there is one LTE-A UE which is capable of up to five active CCs in its DL and/or UL set while another LTE-A is capable of up to eight active CCs in its DL and/or UL set.

From the above premises, an embodiment of the invention provides a UE-specific signaling carrier indicator by which the wireless network signals to the UE the specific DL or UL CC to which the RRC signaling information is to be applied, and the UE will utilize the indicated DL and/or UL CC accordingly. For example, the network may send RRC signaling for configuring a DL channel together with a signaling carrier indicator; the indicator points to a specific DL CC and the UE configures that DL CC as the RRC signaling directs. In an exemplary embodiment this UE-specific signaling carrier indicator is set up at RRC connection establishment, and remains valid for that UE until re-configured (such as upon handover or at the network's discretion). Therefore a static signaling carrier index is not needed. In general, the RRC signaling according to these teachings can be sent during any configuration or re-configuration of the UE, not only during connection establishment or re-establishment.

Consider an example for a LTE-A capable UE which is establishing a connection with a system using CA of eight CCs. The UE has a maximum DL/UL CC capability of five CCs. Upon connection establishment, the UE sends to the network its capability information which in an embodiment includes the UE's maximum number of active DL/UL CCs, five in this instance. Assume that the UE's active CC set consists of CC#1, CC#2 and CC#4. In an exemplary embodiment the network sends some RRC signaling to the UE to configure all three of those CCs, and also signals in that same message a signaling carrier indicator for each of those CCs in that are being configured. By example, assume that the network sends in this message six signaling carrier indicators, three DL CCs and three UL CCs, with the six different RRC configurations. The UE applies those RRC configurations to the UL and DL CCs that are pointed to by the signaling carrier indications, regardless of which CC the RRC information and carrier indications were received. In this instance there is a DL and a UL in each of CC#s 1, 2 and 4, but such DL:UL symmetry is not a limitation to embodiments of the invention. Following is a non-limiting example.

First RRC information is sent together with a first signaling carrier indicator, which informs the UE that the first RRC information is for the DL in CC#1. Second RRC information is sent together with a second signaling carrier indicator, which informs the UE that the second RRC information is for the UL in CC#1. Third RRC information is sent together with a third signaling carrier indicator, which informs the UE that the third RRC information is for the DL in CC#2. Fourth RRC information is sent together with a fourth signaling carrier indicator, which informs the UE that the fourth RRC information is for the UL in CC#2. Fifth RRC information is sent together with a fifth signaling carrier indicator, which informs the UE that the fifth RRC information is for the DL in CC#4. Sixth RRC information is sent together with a sixth signaling carrier indicator, which informs the UE that the sixth RRC information is for UL in CC#4. The n^{th} RRC information is sent together with the n^{th} signaling carrier indicator, and the above example may be implemented in one message (six distinct RRC information with six distinct carrier indications) or in six distinct messages (each of six distinct messages has one RRC information with one carrier indication) or some combination thereof in which the total number of messages is between one and six.

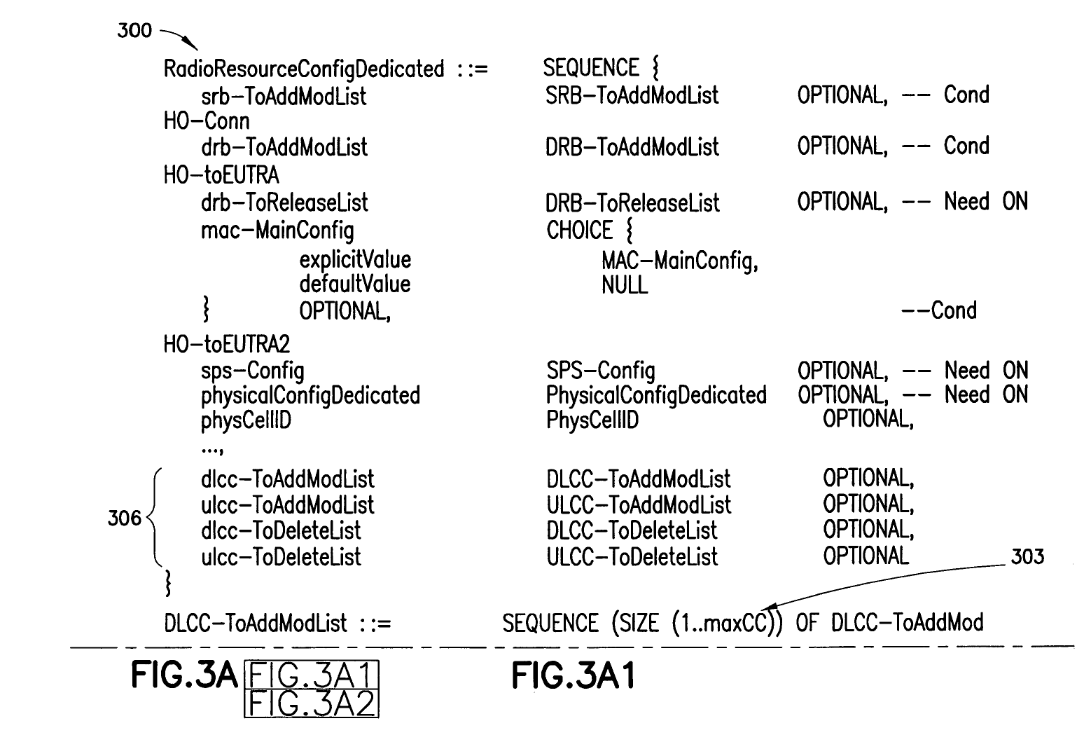

FIG. 2 illustrates a simple example in which there is RRC signaling that is to be applied on both DL and UL channels. The UE's cell is CC#3 and so it establishes a connection there using a random access procedure for example. Upon connection establishment the UE receives RRC signaling 200 with two signaling carrier indications. pointing respectively to the UL and to the DL on CC#5. The UE reads the signaling carrier indications and applies 210 the received RRC signaling 200 on the two indicted CCs, which are shown in FIG. 2 as 205D for DL CC#5 and 205U for UL CC#5. In this example the same RRC signaling is for both UL and DL in CC#5, whereas in the example above different RRC signaling applied for the opposed DL and UL channels of the same CC.

As noted above, the signaling carrier indicators are set up upon connection establishment, whether initial logon to a network by a UE just powering on or when the UE hands over from one eNB to another, and in an exemplary embodiment remain valid until the network reconfigures the signaling carrier indicator (which may occur apart from handover).

In another embodiment there is one signaling carrier indicator per CC of the set, which would for the example above in which the UE has CC#s 1, 2 and 4 in its active set would use only three signaling carrier indicators since there would only be one per CC rather than one per DL CC and one per UL CC. In this embodiment there is further a pre-arranged rule for how the DL and UL RRC information is sent, for example an indicator for CC#1 means both the DL for CC#1 and the UL for CC#1 are indicated by the one signaling carrier indicator.

In an embodiment, the network sends its PDCCH for scheduling the UE for radio resources on a DL CC of the UE's active set of CCs, and the UE sends its acknowledgement or negative acknowledgement for that same PDCCH on the UL CC that maps to the DL CC, but in this example there is also a signaled carrier indicator that indicates on which CC those PDCCH-allocated resources lie. By example, the network may send a PDCCH in the DL of CC#4 which schedules the UE for traffic (UL or DL shared channel), and with that PDCCH the network also sends a signaling carrier indicator to point to which CC that schedule applies. The signaling carrier indicator may in one embodiment point to CC#4 (same as where the PDCCH was sent) and in another embodiment it may point to a different CC which is generally termed cross-scheduling. The UE properly receives that PDCCH, sends its acknowledgement on the UL control channel in CC#4 that maps to the PDCCH, and sends or receives traffic in the slots indicated by the PDCCH but in the CC indicated by the carrier indicator. The acknowledgement for the traffic is on a channel that maps to the traffic channel and in the same CC as the traffic channel, according to an exemplary embodiment of the invention.

In the above examples, there is a different UE specific signaling carrier indicator per CC of the UE's active set (and one example gives separate CC indications for UL and for DL). This gives the network the capability to provide RRC information to the UE on any of the DL CCs in the UE's active set which it monitors, and that RRC information can have a pointer (the carrier indicator) to any of the CCs. That is, the network can send on a first CC RRC information that relates to a second CC. In an embodiment that first CC is the UE's serving cell on which it establishes (or re-establishes) its connection with the multi-carrier network.

Note that the RRC information can also add or delete any individual CC from the UE's active set. For example, if the UE is configured such that its active CC set is CC#1, CC#2 and CC#4, changes to network utilization may make it productive to reduce the UE's set to only CC#1 and CC#4. In this case the network can simply delete CC#2 from the UE's configured set by sending RRC information to delete a CC and a carrier indicator to point to CC#2 as the CC to which the delete instruction applies, and the network can send this delete RRC instruction (and carrier indicator) on any of CC#s 1, 2 or 4 for that UE. Similarly, if conditions are such that the network finds it useful to modify the UE's active set by adding a CC or changing the UE's configured set, the network can to the UE RRC signaling to add a new CC to its active set and an indicator of which CC is being added. Similarly, changing a CC of the UE's current set to a different CC can by example be implemented as a simultaneous adding of a CC and dropping of another CC, with carrier indicators pointing to which CC the add command relates and which CC the drop command relates. In an exemplary embodiment the total CCs in the system bandwidth may be indexed and the signaling carrier indication pointing to which CC to add, drop or change refers to the index, which reduces the number of signaling bits required. Signaling to inform the UE of the indexing itself can be explicit or implicit.

The UE-specific signaling carrier indicators are set-up at UE connection establishment/re-establishment, or at any configuration/re-configuration of the UE. The UE-specific signaling carrier indicators are then sent with the RRC signaling to indicate the DL and/or UL CC to which the RRC content refers. Parameters from 3GPP Release 8 can be re-used in LTE-A to signal the serving cell configuration, and in an exemplary embodiment the serving cell configuration can additionally include a DL CC list and an UL CC list to configure the UL and DL CCs independently as noted above. In a particular embodiment these lists are in separate information element groups.

During the time that Release 8 UEs co-exist with LTE-A UEs there will be Release 8 UEs that cannot take advantage of the signaling carrier indicator as detailed above. In an embodiment of the invention the UE signals its capability information in its RRC signaling, specifically the maximum number of CCs of which it is capable of operating in simultaneously. As in the above example the network/eNB uses this capability information and sends RRC signaling along with the signaling carrier indicator(s) to only those UEs who signal a multi-CC capability, since these indicators are UE-specific.

In an embodiment, the network treats all UEs as Release 8 UEs until the UE capabilities have been successfully inquired by the network. In an embodiment the UE capability inquiry procedure is the same as in LTE Release 8, and this inquiry is performed in the serving cell/CC. In order to keep this capability inquiry by the network transparent to the Release 8 UEs, in one particular but non-limiting embodiment the Release 8 UECapabilityInformation message is extended with an additional information element which is generically termed here a ueCapabilityInformation-r10 (for LTE Release 10) such that the Release 8 UE capability information can be overwritten where applicable by a Release 10/LTE-A UE.

In the Release 10 capability IE, in addition to the LTE Release 8 RAT capability container UE-CapabilityRAT-ContainerList, the reporting UE can specify its further capability details in a new information element which is generically termed herein as UE-EUTRA-IMTA-Capability. In an exemplary embodiment this new information element includes the definition of the UE's component carrier support, for example the maximum size of the UE DL CC set and of the UE UL CC set which the UE can handle.

Apart from the above inquiry procedure is the status of an RRC connection with the one serving cell. This connection may exclusively use the DL CC and the UL CC belonging to the serving cell/CC, or it may also use extra resources from the UE's DL CC set and UL CC set for reception and transmission. For the case where these extra resources/other CCs are involved, there may also be the need for the network to send CC-specific configurations or parameters to the LTE-A UE (for example, a parameter set for UL CC-specific power control). Since the Release 8 signaling unambiguously binds the content of the information element to the serving cell, and the LTE-A UE on the other hand has to be told which DL and/or UL CC the CC-specific information is meant for, then in an exemplary embodiment the IEs are extended with the signaling carrier indicator detailed above.

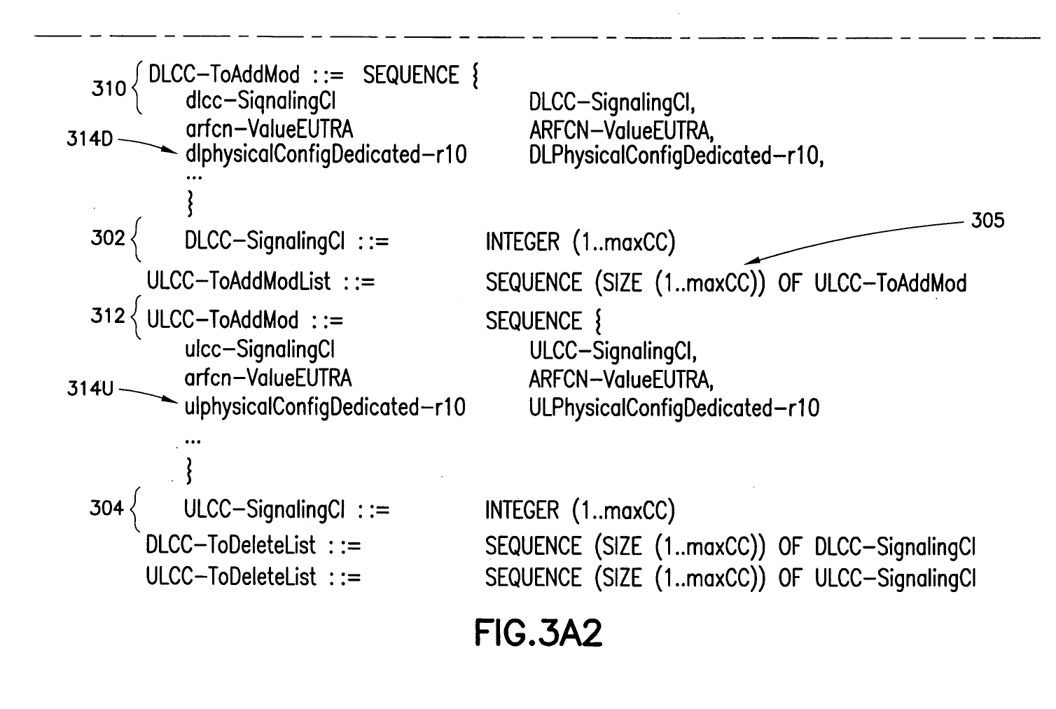

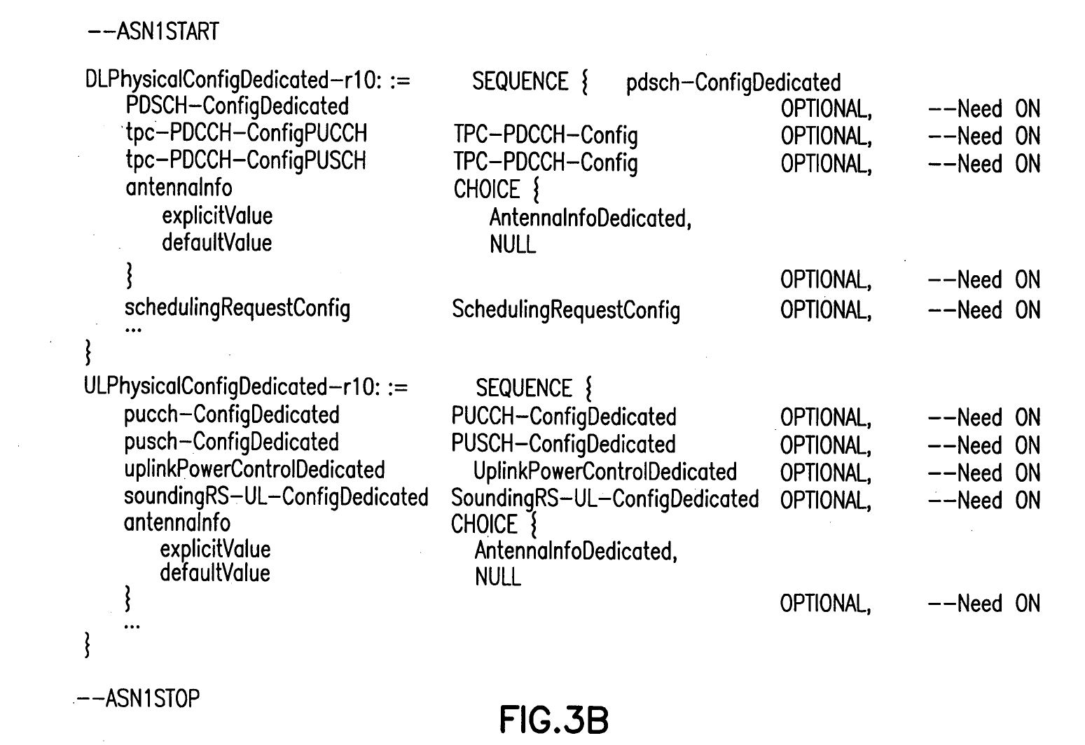

In an embodiment, any introduction of, or configuration with respect to a DL and/or UL CC, as well as the introduction of a UE-specific signaling carrier indicator, happens through the DL-DCCH message element RRCConnectionReconfiguration message whose rrcConnectionReconfiguration information RadioResourceConfigDedicated 300 shown at FIG. 3A could be extended as detailed above with a DL scheduling carrier indication 302, an UL scheduling carrier indication 304, and DL and UL CC lists 306. Each of the DL and UL scheduling carrier indications 302, 304 list separately each of the CCs of the UE's active set which have UL and DL control channels, with the specific channels given in the lists 306.

This is one exemplary embodiment for an LTE Release 8-like extension of the radio resources available to the RRC connection, and also defines the UE-specific/connection-specific DL CC signalling carrier indices as well as the UL CC signalling carrier indices that are valid for this RRC connection, in which the indices 303, 305 are given as the “sequence (size (1 . . . macCC))” at FIG. 3A. FIG. 3A is a specific exemplary embodiment of RRC signaling 300 that is sent along with a signaling carrier indicator which is shown as DLPhysicalConfigDedicated-r10 314D and ULPhysicalConfigDedicated-r10 314U, of which the former is further detailed at FIG. 3B.

FIG. 3B is another exemplary example of RRC signaling along with a new DLPhysicalConfigDedicated-r10 and ULPhysicalConfigDedicated-r10 information element that points to which DL and UL CC the RRC signaling relates according to an exemplary embodiment of the invention. In the FIG. 3B examples the PDSCH and PDCCH are configured on the DL and the PUSCH and PUCCH are configured on the UL, as well as antenna ports and sounding reference signal information.

According to the above description and specific exemplary embodiments, the DL and/or UL CC specific re-configurations or parameters can be changed. By example and not by way of limitation, the UE-specific and CC-specific downlink parameters may include the following:
The UE being semi-statically configured via higher layer signaling to receive PDSCH data transmissions signaled via PDCCH UE specific search spaces, according to one of seven transmission modes, denoted mode 1 to mode 7
The UE is restricted to report PMI and RI within a pre-coder codebook subset specified by a bitmap parameter codebookSubsetRestriction configured by higher layer signaling.
The UE is informed by higher layers whether the UE-specific reference signal is present and is a valid reference for PDSCH demodulation or not.
DL power allocation parameters.

By further example and not by way of limitation, the UE-specific and CC-specific uplink parameters may include the following:
All UL power control parameter settings specific to the UE such P_{O}_{_{—}}_{UE}_{_{—}}_{PUSCH} (j), or P_{O}_{_{—}}_{UE}_{_{—}}_{PUCCH}
PUCCH configuration parameters
UL CC specific and UE-specific TTI Bundling (?)
If the UE is capable of supporting 64QAM in PUSCH and has not been configured by higher layers to transmit only QPSK and 16QAM, the modulation order is given by in in Table 8.6.1-1.
Parameters for the UE sounding procedure

In another exemplary but non-limiting embodiment, to minimize/reduce the downlink signaling overhead associated with the RRC (re-)configuration of the CCs, and to ensure a consistent indexing of CCs used for the signaling carrier indications, the signaling carrier indications are linked to their CC ARFCN. Specifically, this means that in the proposed DLCC-ToAddMod 310 and ULCC-ToAddMod 312 of FIG. 3A, the SignalingCI Indicator would not be needed as the indicator of the CC would implicitly be given, in this non-limiting example by its ARFCN value. For instance, considering 3 CCs:
First CC: EARFCN X→CC ID #1
Second CC: EARFCN X+3→CC ID #2
Third CC: EARFCN X+4→CC ID #3

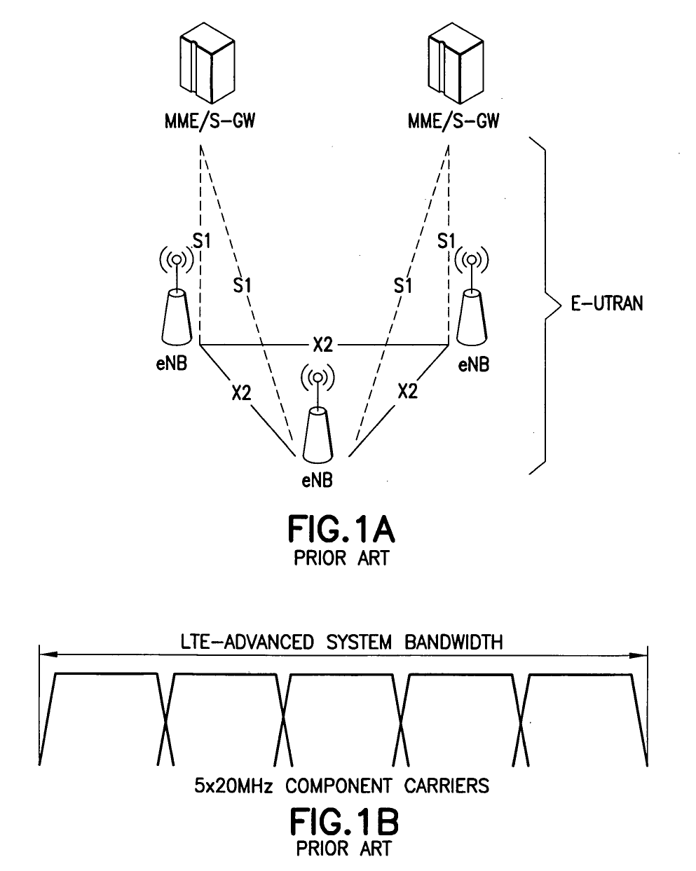

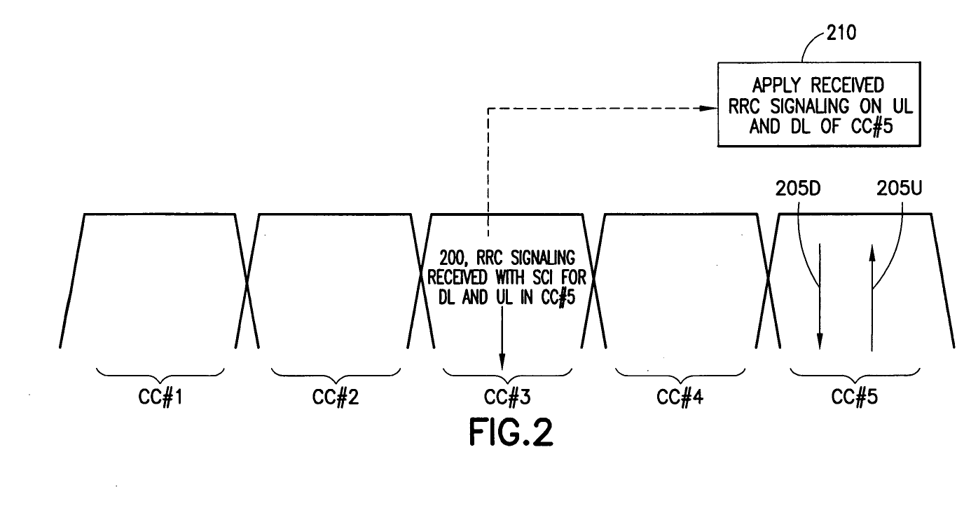

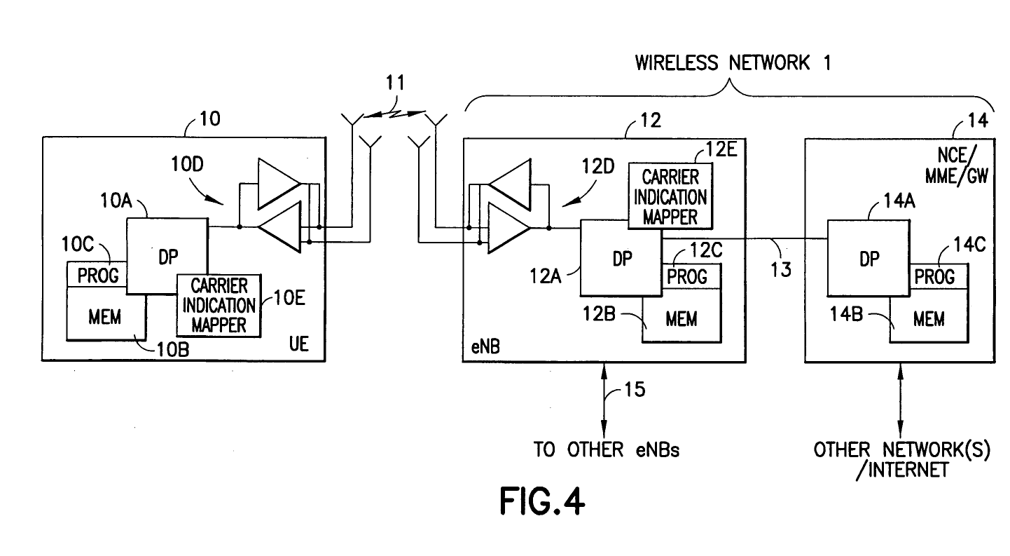

Reference is now made to FIG. 4 for illustrating a simplified block diagram of various electronic devices and apparatus that are suitable for use in practicing the exemplary embodiments of this invention. In FIG. 4 a wireless network 1 is adapted for communication over a wireless link 11 with an apparatus, such as a mobile communication device which above is referred to as a UE 10, via a network access node, such as a Node B (base station), and more specifically an eNB 12. The network 1 may include a network control element (NCE) 14 that may include the MME/S-GW functionality shown in FIG. 1A, and which provides connectivity with a network, such as a telephone network and/or a data communications network (e.g., the internet). The UE 10 includes a controller, such as a computer or a data processor (DP) 10A, a computer-readable memory medium embodied as a memory (MEM) 10B that stores a program of computer instructions (PROG) 10C, and a suitable radio frequency (RF) transceiver 10D for bidirectional wireless communications with the eNB 12 via one or more antennas. The eNB 12 also includes a controller, such as a computer or a data processor (DP) 12A, a computer-readable memory medium embodied as a memory (MEM) 12B that stores a program of computer instructions (PROG) 12C, and a suitable RF transceiver 12D for communication with the UE 10 via one or more antennas. The eNB 12 is coupled via a data/control path 13 to the NCE 14. The path 13 may be implemented as the S1 interface shown in FIG. 1A. The eNB 12 may also be coupled to another eNB via data/control path 15, which may be implemented as the X2 interface shown in FIG. 1A.

At least one of the PROGs 10C and 12C is assumed to include program instructions that, when executed by the associated DP, enable the device to operate in accordance with the exemplary embodiments of this invention, as will be discussed below in greater detail.

That is, the exemplary embodiments of this invention may be implemented at least in part by computer software executable by the DP 10A of the UE 10 and/or by the DP 12A of the eNB 12, or by hardware, or by a combination of software and hardware (and firmware).

For the purposes of describing the exemplary embodiments of this invention the UE 10 may be assumed to also include a signaling carrier indicator mapper 10E, and the eNB 12 may also similarly include a signaling carrier mapper 12E. These mappers 10E, 12E determine which CC is pointed to by which signaling carrier indictor, such as for example by indexing CCs such that the indicator that is sent with the RRC information is an index into a table of CCs.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 10B and 12B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on a multicore processor architecture, as non-limiting examples.

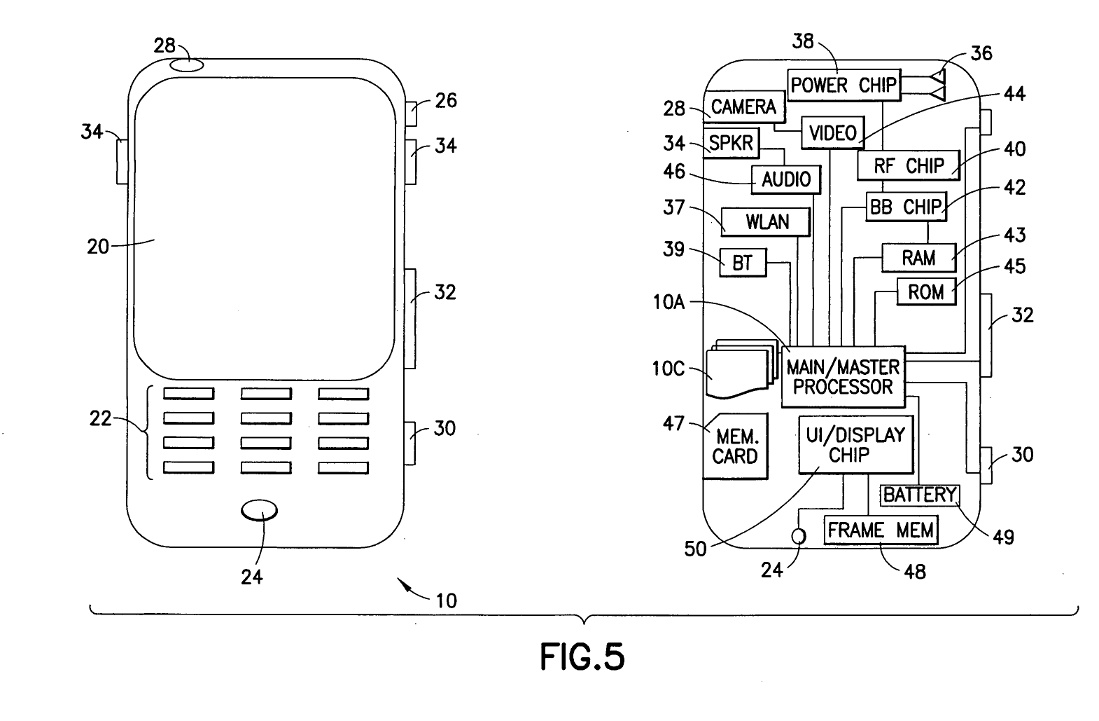

FIG. 5 illustrates further detail of an exemplary UE in both plan view (left) and sectional view (right), and the invention may be embodied in one or some combination of those more function-specific components. At FIG. 5 the UE 10 has a graphical display interface 20 and a user interface 22 illustrated as a keypad but understood as also encompassing touch-screen technology at the graphical display interface 20 and voice-recognition technology received at the microphone 24. A power actuator 26 controls the device being turned on and off by the user. The exemplary UE 10 may have a camera 28 which is shown as being forward facing (e.g., for video calls) but may alternatively or additionally be rearward facing (e.g., for capturing images and video for local storage). The camera 28 is controlled by a shutter actuator 30 and optionally by a zoom actuator 32 which may alternatively function as a volume adjustment for the speaker(s) 34 when the camera 28 is not in an active mode.

Within the sectional view of FIG. 5 are seen multiple transmit/receive antennas 36 that are typically used for cellular communication. The antennas 36 may be multi-band for use with other radios in the UE. The power chip 38 controls power amplification on the channels being transmitted and/or across the antennas that transmit simultaneously where spatial diversity is used, and amplifies the received signals. The power chip 38 outputs the amplified received signal to the radio-frequency (RF) chip 40 which demodulates and downconverts the signal for baseband processing. The baseband (BB) chip 42 detects the signal which is then converted to a bit-stream and finally decoded. Similar processing occurs in reverse for signals generated in the apparatus 10 and transmitted from it.

Signals to and from the camera 28 pass through an image/video processor 44 which encodes and decodes the various image frames. A separate audio processor 46 may also be present controlling signals to and from the speakers 34 and the microphone 24. The graphical display interface 20 is refreshed from a frame memory 48 as controlled by a user interface chip 50 which may process signals to and from the display interface 20 and/or additionally process user inputs from the keypad 22 and elsewhere.

Certain embodiments of the UE 10 may also include one or more secondary radios such as a wireless local area network radio WLAN 37 and a Bluetooth® radio 39, which may incorporate an antenna on-chip or be coupled to an off-chip antenna. Throughout the apparatus are various memories such as random access memory RAM 43, read only memory ROM 45, and in some embodiments removable memory such as the illustrated memory card 47 on which the various programs 10C are stored. All of these components within the UE 10 are normally powered by a portable power supply such as a battery 49.

The aforesaid processors 38, 40, 42, 44, 46, 50, if embodied as separate entities in a UE 10 or eNB 12, may operate in a slave relationship to the main processor 10A, 12A, which may then be in a master relationship to them. Embodiments of this invention need not be disposed in any individual processor/chip but may be disposed across various chips and memories as shown or disposed within another processor that combines some of the functions described above for FIG. 5. Any or all of these various processors of FIG. 5 access one or more of the various memories, which may be on-chip with the processor or separate therefrom. Similar function-specific components that are directed toward communications over a network broader than a piconet (e.g., components 36, 38, 40, 42-45 and 47) may also be disposed in exemplary embodiments of the access node 12, which may have an array of tower-mounted antennas rather than the two shown at FIG. 5.

Note that the various chips (e.g., 38, 40, 42, etc.) that were described above may be combined into a fewer number than described and, in a most compact case, may all be embodied physically within a single chip.

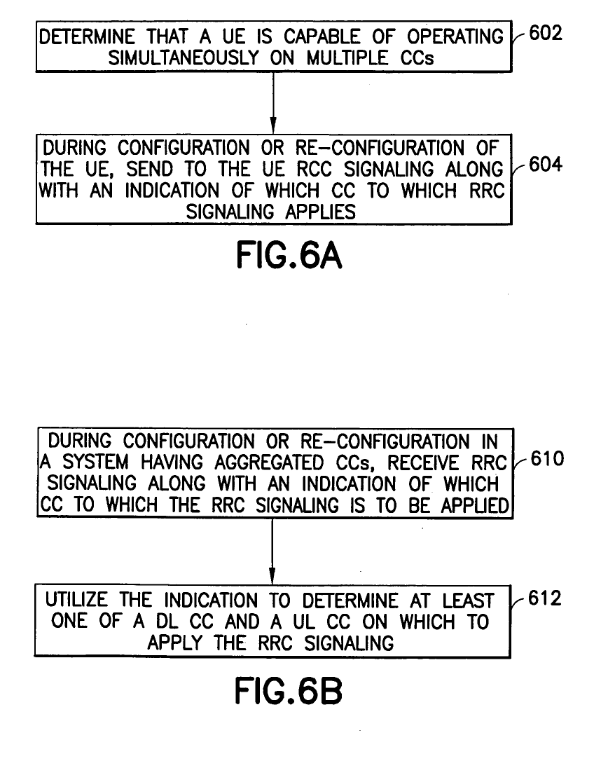

FIG. 6A is a logic flow diagram that illustrates the operation of a method, and a result of execution of computer program instructions, in accordance with the exemplary embodiments of this invention from the perspective of a network element such as for example the eNB/access node or the MME/higher network node of a communication system having a plurality of aggregated component carriers. In accordance with these exemplary embodiments at block 602 the network element determines that a user equipment is capable of operating simultaneously on multiple component carriers. As noted above this is in an exemplary embodiment from a user equipment capability information element that the network element receives from the user equipment and which indicates at least a maximum number of downlink or uplink component carriers on which the user equipment can simultaneously communicate.

Further at FIG. 6A at block 604, during configuration or re-configuration (such as for example during connection establishment/re-establishment of the user equipment to a cell of the communication system), the network element sends to the user equipment RRC signaling along with an indication of which of the plurality of component carriers to which the radio resource control signaling applies. As noted above, in one embodiment there may be a user equipment specific signaling carrier indicator for each of the component carriers to which the radio resource control signaling applies, and in another embodiment there may be a separate user equipment specific signaling carrier indicator for each of the downlink component carriers and for each of the uplink component carriers to which the radio resource control signaling applies.

FIG. 6B is a logic flow diagram that illustrates the operation of a method, and a result of execution of computer program instructions, in accordance with the exemplary embodiments of this invention from the perspective of a user equipment. In accordance with these exemplary embodiments at block 610, during configuration or re-configuration (such as for example during connection establishment/re-establishment) in a communication system having a plurality of aggregated component carriers, there is received (from a cell of the system) RRC signaling along with an indication of which of the plurality of component carriers on which to apply the radio resource control signaling.

In the specific non-limiting embodiments detailed above this indication may comprises a user equipment specific signaling carrier indicator for each of the component carriers on which the radio resource control signaling is to be communicated with the communication system, and in another embodiment there is a separate user equipment specific signaling carrier indicator for each of the downlink component carriers and for each of the uplink component carriers to which the radio resource control signaling is to be applied. In an exemplary embodiment the RRC signaling along with the indication is received in reply to the UE sending to the cell a user equipment capability information element which indicates at least a maximum number of downlink or uplink component carriers on which the UE can simultaneously communicate.

Further at FIG. 6B at block 612 the UE utilizes the indication to determine at least one of a downlink component carrier and an uplink component carriers to which the RRC signaling is to be applied. In one of the examples above the RRC signaling is a PDCCH on the DL and the signaling carrier indication points to which (DL or UL) CC on which the allocated resources are located.

The various blocks shown in FIGS. 6A-B may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the LTE-Advanced system, it should be appreciated that the exemplary embodiments of this invention are not limited for use with only this one particular type of wireless communication system that uses carrier aggregation.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters and channels (for example, DL-DCCH, PDCCH, etc.) are not intended to be limiting in any respect, as these parameters may be identified by any suitable names. Some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method, comprising:
determining, by an apparatus of a communication system having a plurality of aggregated component carriers, that a user equipment is capable of operating simultaneously on multiple component carriers; and
during configuration or re-configuration of the user equipment, the apparatus sending to the user equipment radio resource control signaling together with an indication of which of the plurality of component carriers to which the radio resource control signaling applies.

2. The method according to claim 1, in which the determining is from a user equipment capability information element received from the user equipment which indicates at least a maximum number of downlink or uplink component carriers on which the user equipment can simultaneously communicate.

3. The method according to claim 1, in which the indication comprises a user equipment specific signaling carrier indicator for each of the component carriers to which the radio resource control signaling applies.

4. The method according to claim 3, in which the configuration or re-configuration comprises at least one of connection establishment by the user equipment to the communication system and connection re-establishment by the user equipment to the communication system.

5. The method according to claim 3, in which there is a separate user equipment specific signaling carrier indicator for each downlink component carrier and for each uplink component carrier to which the radio resource control signaling applies.

6. An apparatus, comprising:
at least one processor; and
at least one memory including computer program code;
the at least one memory and the computer program code configured to, with the at least one processor, cause the apparatus to perform:
determining that a user equipment is capable of operating simultaneously on multiple component carriers of a plurality of aggregated component carriers of a communication system; and
during configuration or re-configuration of the user equipment, sending to the user equipment radio resource control signaling together with an indication of which of the plurality of component carriers to which the radio resource control signaling applies.

7. The apparatus according to claim 6, in which the determining is from a user equipment capability information element, received by the apparatus from the user equipment, which indicates at least a maximum number of downlink or uplink component carriers on which the user equipment can simultaneously communicate.

8. The apparatus according to claim 6, in which the indication comprises a user equipment specific signaling carrier indicator for each of the component carriers to which the radio resource control signaling applies.

9. The apparatus according to claim 8, in which the configuration or re-configuration comprises at least one of connection establishment by the user equipment to the communication system and connection re-establishment by the user equipment to the communication system.

10. The apparatus according to claim 9, in which there is a separate user equipment specific signaling carrier indicator for each downlink component carrier and for each uplink component carrier to which the radio resource control signaling applies.

11. A computer readable memory storing a program of computer readable instructions that when executed by a processor result in actions comprising:
determining that a user equipment is capable of operating simultaneously on multiple component carriers of a communication system having a plurality of aggregated component carriers; and
during configuration or re-configuration of the user equipment, sending to the user equipment radio resource control signaling together with an indication of which of the plurality of component carriers to which the radio resource control signaling applies.

12. A method, comprising:
during configuration or re-configuration in a communication system having a plurality of aggregated component carriers, an apparatus receiving radio resource control signaling together with an indication of which of the plurality of component carriers to which the radio resource control signaling is to be applied; and
the apparatus utilizing the indication to determine at least one of a downlink component carrier and an uplink component carrier on which to apply the radio resource control signaling.

13. The method according to claim 12, in which the indication is received in reply to sending a user equipment capability information element which indicates at least a maximum number of downlink or uplink component carriers on which a user equipment executing the method can simultaneously communicate.

14. The method according to claim 12, in which the indication comprises a user equipment specific signaling carrier indicator for each of the component carriers on which the radio resource control signaling is to be applied.

15. The method according to claim 14, in which there is a separate user equipment specific signaling carrier indicator for each of the downlink component carriers and for each of the uplink component carriers to which the radio resource control signaling is to be applied.

16. An apparatus comprising:
at least one processor; and
at least one memory including computer program code;
the at least one memory and the computer program code configured to, with the at least one processor, cause the apparatus to perform:
during configuration or re-configuration in a communication system having a plurality of aggregated component carriers, receiving radio resource control signaling together with an indication of which of the plurality of component carriers to which the radio resource control signaling is to be applied; and
utilizing the indication to determine at least one of a downlink component carrier and an uplink component carrier on which to apply the radio resource control signaling.

17. The apparatus according to claim 16, in which the indication is received in reply to the apparatus sending a user equipment capability information element which indicates at least a maximum number of downlink or uplink component carriers on which the apparatus can simultaneously communicate.

18. The apparatus according to claim 16, in which the indication comprises a user equipment specific signaling carrier indicator for each of the component carriers on which the radio resource control signaling is to be applied.

19. The apparatus according to claim 18, in which there is a separate user equipment specific signaling carrier indicator for each of the downlink component carriers and for each of the uplink component carriers to which the radio resource control signaling is to be applied.

20. A computer readable memory storing a program of computer readable instructions that when executed by a processor result in actions comprising:
during configuration or re-configuration in a communication system having a plurality of aggregated component carriers, receiving radio resource control signaling together with an indication of which of the plurality of component carriers to which the radio resource control signaling is to be applied; and
utilizing the indication to determine at least one of a downlink component carrier and an uplink component carrier on which to apply the radio resource control signaling.
